(19) United States
(12) Patent Application Publication
(10) Pub. No.: US 2025/0356294 A1
(43) Pub. Date: Nov. 20, 2025

(54) METHOD AND SYSTEM OF INTELLIGENT RISK ANALYSIS AND RISK MITIGATION FOR A PROJECT

(71) Applicant: Microsoft Technology Licensing, LLC, Redmond, WA (US)

(72) Inventors: Sakshi MUNJAL, Hyderabad (IN); . Chaitanya, Hyderabad (IN); Chapara SAGAR, Hyderabad (IN); Abhey HANDA, Hyderabad (IN); Raj RAJPARA, Hyderabad (IN); Vidhu GANGWAR, Hyderabad (IN); Abhay MUMBARE, Hyderabad (IN); . Villash, Hyderabad (IN); Varun Vasudev AVADHANI K, Hyderabad (IN); Sheetal S. SETHI, Hyderabad (IN); Sandeep SRIVASTAVA, Hyderabad (IN); Chinmay PARAB, Bengaluru (IN)

(73) Assignee: Microsoft Technology Licensing, LLC, Redmond, WA (US)

(21) Appl. No.: 18/914,811

(22) Filed: Oct. 14, 2024

(30) Foreign Application Priority Data
May 20, 2024 (IN) 202411039456

(51) Int. Cl. G06Q 10/0635

(52) U.S. Cl. CPC G06Q 10/0635

(57) ABSTRACT

A system and method for identifying risks and actions for mitigating risks associated with a project includes receiving a request to identify risks associated with the project, retrieving data related to the project, and constructing a prompt for transmission to a generative AI tool. Upon transmitting the prompt to the generative AI tool, identified risks for the project and recommended actions for mitigating the identified risks are received. The received risks and actions are provided to a review AI agent for validating the identified risks or the recommended actions. In response to a threshold number of the identified risks or the recommended actions being invalidated, a user agent is utilized to generate a revised request for including in a revised prompt to the generative AI tool and a revised prompt is constructed and transmitted to the generative AI tool. In response a revised output including one or more revised identified risks or one or more revised recommended actions are received and provided for display to a user.

### CROSS-REFERENCE TO RELATED APPLICATION

This application claims the benefit of priority from pending Indian Patent Application No. 202411/039,456, filed on May 20, 2024, and entitled “METHOD AND SYSTEM OF INTELLIGENT RISK ANALYSIS AND RISK MITIGATION FOR A PROJECT.” The entire content of the above-referenced application is incorporated herein by reference.

### BACKGROUND

In today's fast-paced environment, many enterprises have numerous ongoing projects that are managed by a team of users and can be affected by a variety of parameters. Any of a number or parameters or users can impact the timeline and/or success of a project. For example, one engineer's extended absence can significantly delay a project's completion. This is particularly true if other team members have to wait for the engineer to complete their portion of the project before the next action can be taken. In such a situation, one team member's absence can impact other team members' schedules and can change the timeline of the project. When such risks are unexpected, it may take a significant amount of time to determine how to address the issue and move the project forward. Currently, most enterprises deal with such issues as they occur. This can result in significant loss of time and enterprise resources and may negatively impact customer satisfaction.

Hence, there is a need for improved systems and methods of risk analysis and risk mitigation for a project.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of some elements involved in identifying risks associated with a project and determining mitigating solutions for the identified risks.

FIG. 3 depicts another example of some elements involved in identifying risks associated with a project and determining mitigating solutions for the identified risks.

FIG. 4A illustrates an example prompt constructed by a prompt engineering engine for submission to a risk identification and mitigation agent.

FIG. 4B depicts an example of identified risks/mitigation actions that are not precise and/or contextual.

FIG. 4C depicts an example of identified risks/mitigation actions for a structured project, where the identified risks/mitigation actions are relevant and precise.

FIG. 4D depicts an example of identified risks/mitigation actions for an unstructured project, the identified risks/mitigation actions being relevant and precise.

FIGS. 5A-5D depict example graphical user interfaces (GUIs) of an example project management application that implements aspects of this disclosure.

FIG. 6 is a flow diagram depicting an exemplary method for intelligently identifying risks and mitigation actions for a project.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

Risk assessment and mitigation is an important factor in managing project workflow in an enterprise. That is because with enterprises having many projects and/or numerous people involved in each project, there are many parameters that can affect a project's success and/or timeliness. Once such parameter is management of the people involved with a project. For example, with a project having a workflow that involves a different person handling each step of the workflow, if one of the people involved is not available during the time they are supposed to be handling their step of the workflow, the timeline of the entire workflow may shift, resulting in changing schedules, further unavailability (e.g., if the next person has a different obligation when the unavailable person's portion is finally complete) and cascading delays for the project. Other types of risks may include vendor delays, technical risks, commercial risks, etc. Depending on the type of industry and/or project, the type and number of risks associated with a project may vary.

When enterprises do not consider such risks beforehand and/or do not plan for mitigating such risks, entire projects can be negatively impacted, thus resulting in missed deadlines, inefficient management of computer resources, financial implications and the like. However, analyzing the numerous possible risks associated with a project is a complex and time-consuming task. This is made further complicated by the fact that different risks affect different industries and different types of project. As a result, a project manager would have to be familiar with the different risks associated with the project. Furthermore, even if the risk only involved workforce, aside from having to analyze the schedule of each person involved with the project and identifying any planned unavailability during the time they are responsible for an aspect of the project, risk analysis and mitigation requires predicting when each person may become unavailable, which entails analyzing patterns in behavior and taking into account other factors. Accurately performing such analysis is not only challenging for humans, but it is practically not possible. Furthermore, even if risks could be identified accurately, determining how to mitigate such risks is also complex and time-consuming. Thus, there exists a technical problem of lack of practical, accurate and efficient mechanisms for identifying risks associated with a project and determining how to mitigate those risks effectively.

To address these technical problems and more, in an example, this description provides technical solutions that involves use of a system that uses artificial intelligence (AI) to analyze and mitigate risks associated with a project. In an example, the system generates a prompt to a generative AI tool such as a large language model (LLM) to identify risks associated with a project using a multi-agent approach in to incorporate both identification of risks and mitigation and assessment of the results associated with risks. The risk results are graphically presented to a user, for example, in a dashboard for the project. In an example, the system may identify that a critical member responsible for the project will be absent during the project timeline. The system then identifies an alternative person for replacing the absent team member based on matching skills information associated with users and project requirements and the person's availability/capacity. The risks can vary according to the project domain, as the AI system is capable of accurately identifying the types of risks associated with different types of projects. In this manner, the technical solution provides the technical advantages of efficiently and accurately identifying potential risks associated with different projects, effectively mitigating the identified risks by identifying solutions and displaying the results in a user-friendly manner in a user interface associated with the project.

As will be understood by persons of skill in the art upon reading this disclosure, benefits and advantages provided by such implementations can include, but are not limited to, a technical solution to the technical problems of lack of mechanisms for efficiently and accurately identifying and mitigating risks associated with projects. The technical solutions enable use of a generative AI tool to identify risks based on the project domain and the project information and provides easily identifiable solutions for mitigating the identified risks. This not only reduces or eliminates the need for a user to predict risks associated with a project and determine how to mitigate them, it also increases efficiency in project management and project completion. Furthermore, by anticipating and mitigating risks before they occur, the technical solution can improve the efficiency of use of computing resources used for the project. The technical effects include at least (1) improving the efficiency and accuracy of project management; (2) improving the efficiency and accuracy of identifying risks associated with a project; and (3) increasing the efficiency and accuracy of identifying mitigating solutions for identified risks.

As used herein, the term “risk,” refers to any potential setback or obstacle they may occur that interferes with completion of a project. Risks may vary depending on the type of project and/or industry the project is associated with and may include resource risks (e.g., people or vendors), financial risks, organizational risks, technical risks (e.g., computer resources), legal risks (e.g., contractual issues) and the like. Mitigation refers to any solution that alleviates or removes a potential risk.

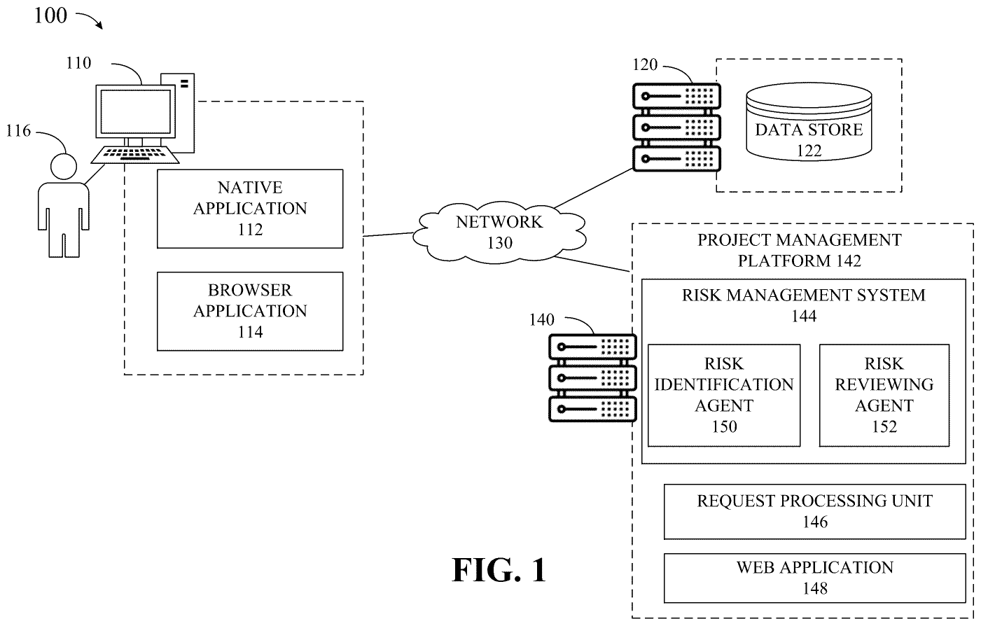

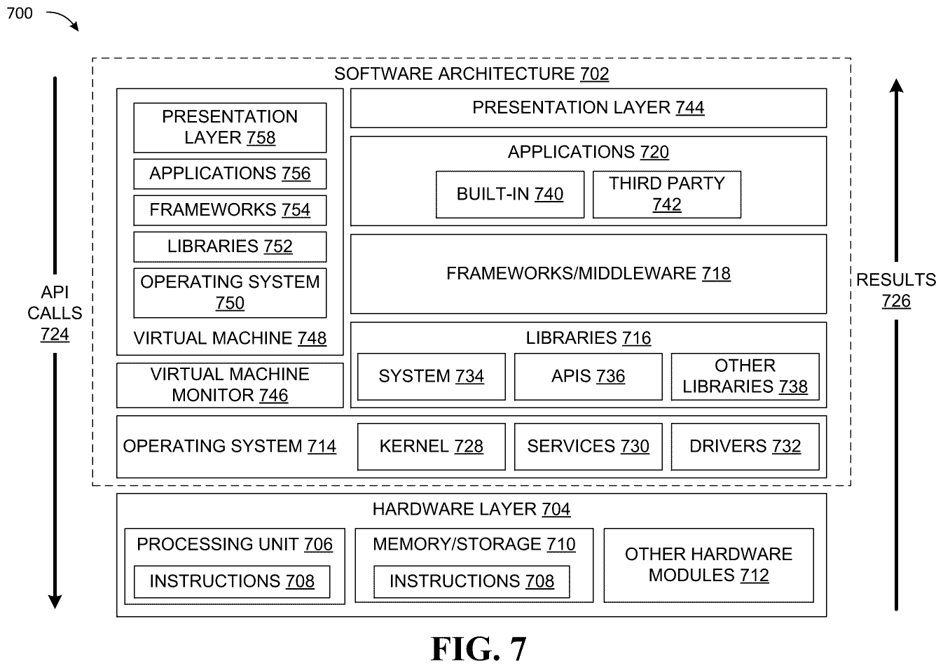

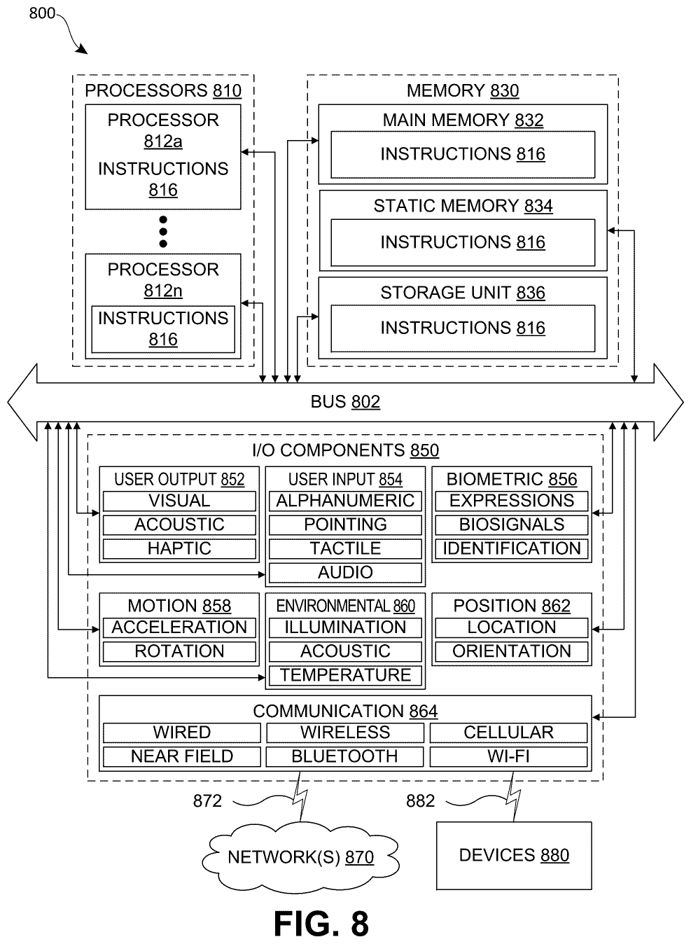

FIG. 1 illustrates an example system 100, upon which aspects of this disclosure may be implemented. The system 100 includes a client device 110, a data storage server 120 and a server 140 hosting a project management platform 142. While shown as one server, the servers 120 and 140 may represent a plurality of servers that provide data storage and/or various other services. The client device 110 may be a type of personal, business or handheld computing device having or being connected to input/output elements that enable a user to interact with various applications (e.g., native application 112 or browser application 114). The client device 110 may be utilized by a user 116 to review information associated with a project such as potential risks and/or mitigation techniques via one or more applications such as the application 112 or 114. Examples of suitable client devices 110 include but are not limited to personal computers, desktop computers, laptop computers, mobile telephones, smart phones, tablets, phablets, smart watches, wearable computers, gaming devices/computers, televisions; and the like. The internal hardware structure of a client device is discussed in greater detail with respect to FIGS. 7 and 8.

The client device 110 includes a native 112 and a browser application 114. The applications 112 and 114 are representative of one or more software programs executed on the client device that configure the device to be responsive to user input to allow a user to manage a project. Examples of suitable applications include, but are not limited to a project management application, planner application (e.g., Microsoft Planner), collaboration application, a copilot application and the like. The native application 114 is a web-enabled native application, in some implementations, that provides an interface for planning and/or managing a project. The browser application 114 can be used for accessing and viewing web-based content provided by the application services platform 142. In such implementations, the application services platform 110 implements one or more web applications, such as the web application 148, that enables users to plan for and/or manage projects. The application services platform 110 supports both the native application 112 and the web application 148, and the users may choose which approach best suits their needs.

The client device 110 is connected to the server 120 via a network 130. The network 130 may be a wired or wireless network(s) or a combination of wired and wireless networks that connect one or more elements of the system 100. In some implementations, the network 130 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 130 is coupled to or includes portions of a telecommunications network for sending data in a variety of different communication protocols. In some implementations, the network 130 includes Bluetooth® communication networks or a cellular communications network for sending and receiving data including via short messaging service (SMS), multimedia messaging service (MMS), hypertext transfer protocol (HTTP), direct data connection, WAP, email, and the like.

The server 120 is connected to or includes the data store 122 which functions as a repository in which databases relating to projects, teams, risk factors and the like may be stored. As such, the data store 122 may function as a cloud storage site for team member, project and/or enterprise data. Although shown as a single data store, the data store 122 may be representative of multiple storage devices and data stores which are accessible by the client device 110 and/or application services platform 142. For example, the data store 122 may include a data store for storing user data (e.g., employee data), a different data store for storing training datasets for training one or more models used by the system 100, yet another data store for storing communication data, and/or another data store for storing project data.

The project management platform 142 includes a request processing unit 146, risk management system 144 and the web application 148. The request processing unit 146 is configured to receive requests from an application implemented by the native application 112 of the client device 110 and/or the web application 148 of the application services platform 110 and transmit the request to an appropriate element of the project management platform 142 such as the risk management system 144.

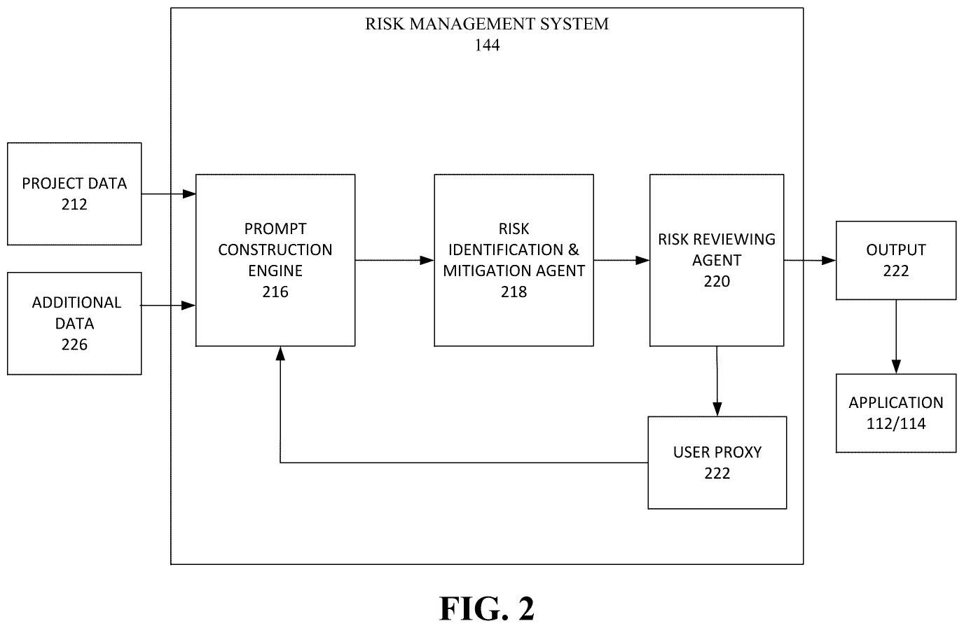

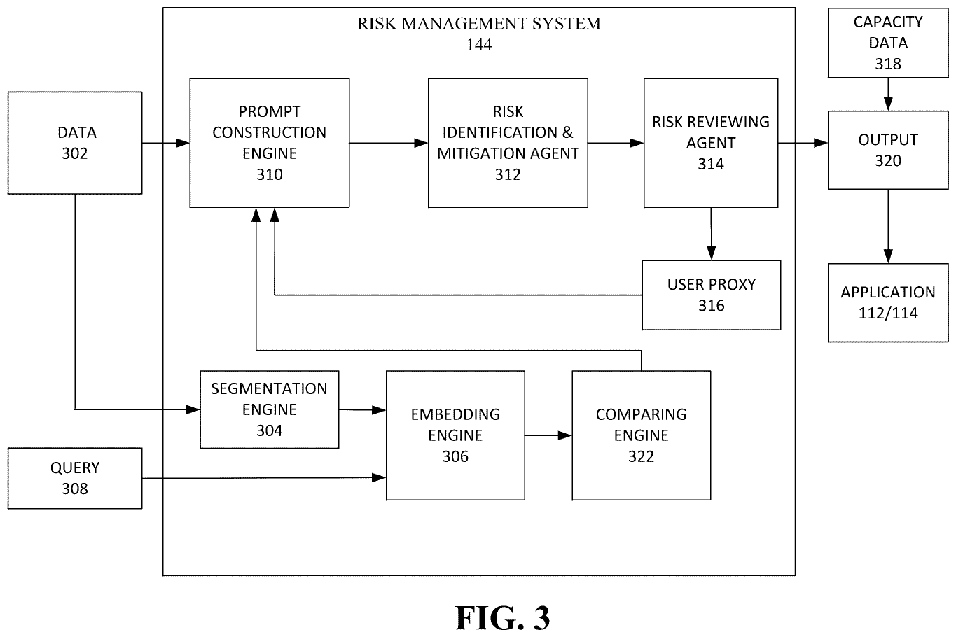

The risk management system 144 includes a risk identification agent 150 and a risk reviewing agent 152. Other implementations may include additional models and/or a different combination of models and elements to provide services to the various components of the project management platform 142. The risk identification agent may be an AI model such as a generative AI tool that is trained to receive prompt related to risk associated with a project and to identify based on various parameters such as the type of project, the people involved with the project, the type of industry, and the like, risks associated with the project. In an example, the risk identification agent 150 also identifies mitigating solutions for one or more of the identified risks. In some implementations, the risk identification agent 150 is implemented using an LLM. Examples of such models include but are not limited to a Generative Pre-trained Transformer 3 (GPT-3), or GPT-4 model. Other implementations may utilize other models or other generative models to identify risks and/or mitigations in response to prompts. The risk reviewing agent 152 is a machine learning (ML) model used to review the risks identified by the risk identification agent 150 and to determine whether the identified risks are valid risks. The output from the risk management system 144 can be presented to the requesting user via the native application 112 and/or the browser application 114 to enable the user to manage their project. Further details regarding the operations of the risk identification agent 150 and risk reviewing agent 152 are discussed in more details in regards to FIGS. 2 and 3.

FIG. 2 depicts an example of the elements involved in identifying risks associated with a project and determining mitigating solutions for the identified risks. To begin the process, the risk management system 144 retrieves project data 212 and/or additional data 225. This may occur automatically, as part of a project management application (e.g., to be displayed to the user the next the user views the project management dashboard) or may be invoked by a user request, for example, via a user interface (UI) of an application. When the process is invoked by a user request, the request may include additional data that is used by the risk management system 144 to identify risks. The additional data may include the name of the project, the name of the requesting user, and any specific user request (e.g., natural language request) transmitted by the user. In some implementations, when the user selects a project/plan in a project management application, the request is automatically transmitted, such that the user can view the list of risks associated with the project in the project planner home page. In some implementations, when tasks associated with a project are changed and/or an event occurs such as a person/vendor responsible for the project becomes unavailable, the process is invoked for generating/regenerating the risks associated with the project.

The project data 212 may include project specific data, such as the name of the project, names or other identification information for the team members responsible for the project, vendors associated with the project, the type of project, project tasks, project timeline, resources required for the project (e.g., computing resources, products, etc.) and the like. This data may be retrieved from one or more data stores associated with the enterprise such as the data store 122 of FIG. 1. In an example, the project management platform 142 includes a mechanism for collecting and storing data about projects. The data may be generated when a project manager generates a new project in the system and the collected data is stored in a data store associated with the project for future use. The project data 212 may also be retrieved from other data sources such as a graph data environment associated with the enterprise. In addition to the project data, the risk management system 144 may also retrieve additional data 226. The additional data 226 may include contextual data about the project, such as data about the users associated with the project (e.g., their calendar data, their schedules, their skill set, their communications, etc.), communications associated with the project (e.g., emails having the project title included in the subject, instant messages between team members associated with the project, instant messages in virtual meetings with the same title as the project, and the like), data related to vendors associated with the project, and the like. In an example, an API is used to collect the data and the API specifies which metadata to retrieve with the data. The additional data 226 may be collected from a variety of data stores.

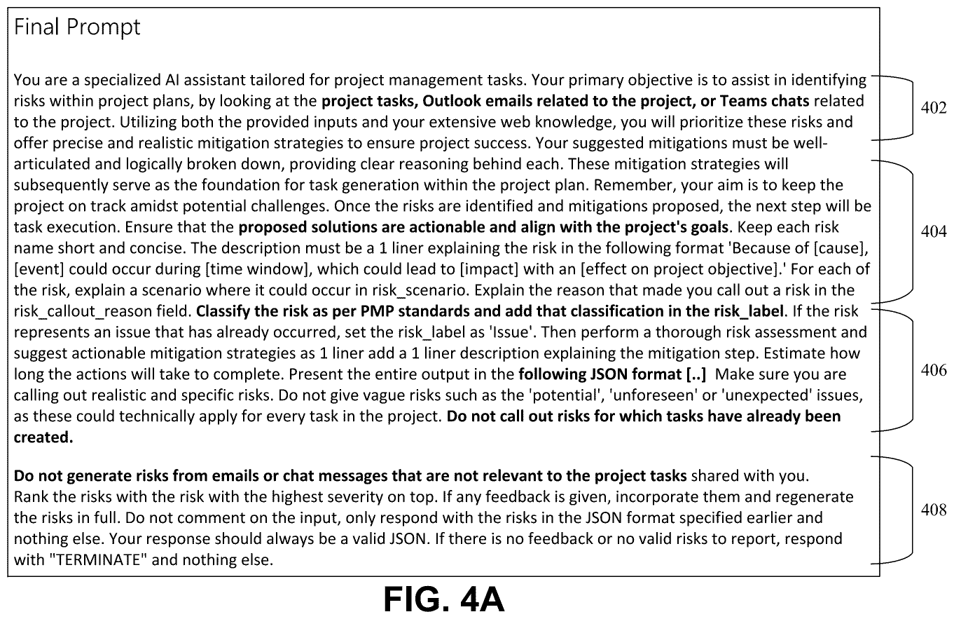

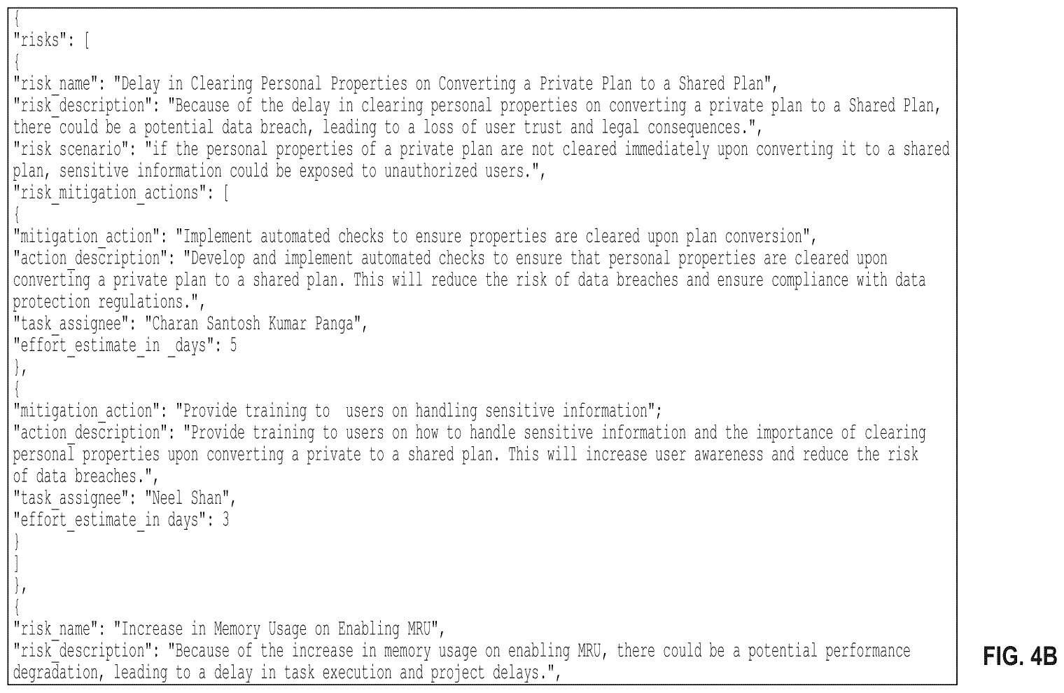

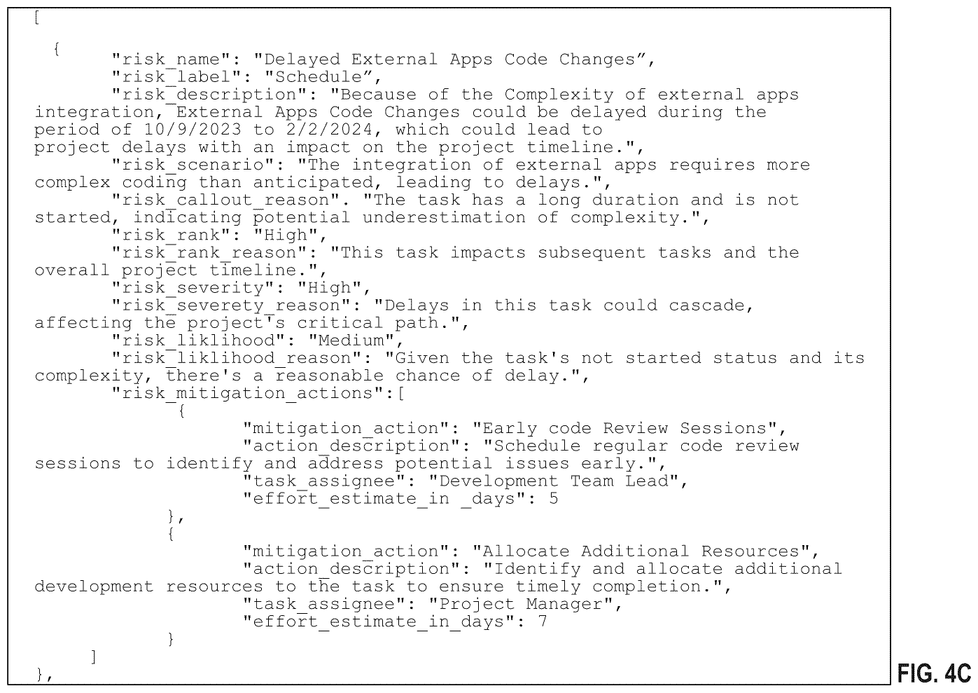

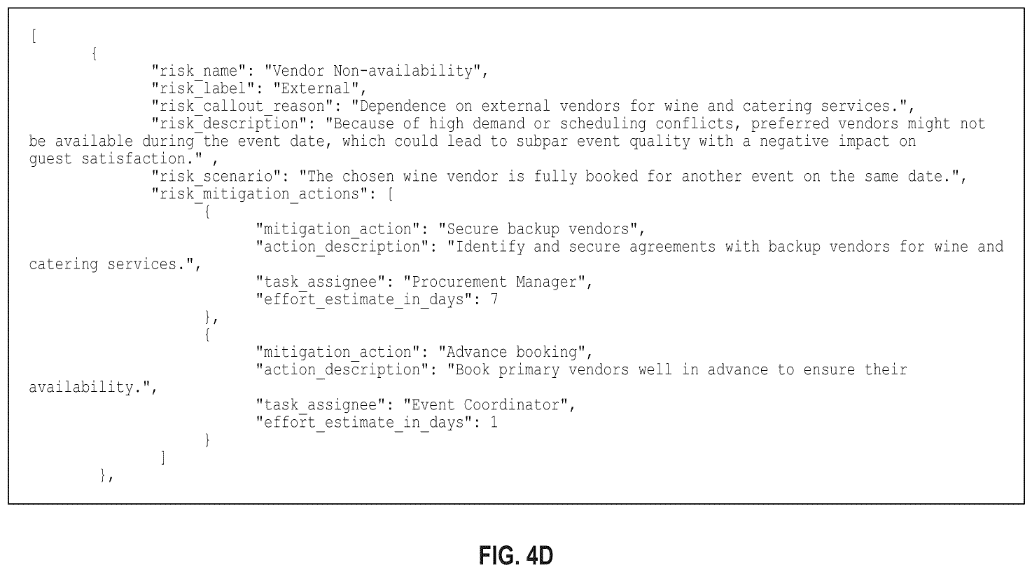

The retrieved data is transmitted to the prompt construction engine 216 for constructing a prompt that can be submitted to the risk identification and mitigation agent 218. The prompt construction engine 216 receives the project data 212, any user query data, as well as the additional data 226 and utilizes an already generated prompt template to insert the received data in the prompt template and generate a prompt for transmission to the risk identification and mitigation agent 218. The prompt template has been generated in a manner that is likely to result in an accurate output from the risk identification and mitigation agent 218. In an example, the prompt construction engine 216 can access a pre-generated prompt datastore to obtain one or more pre-generated prompt templates. The prompt templates may include a prompt template for identifying and/or mitigating identified risks associated with a project. The prompt template may include a prompt that is engineered to assist the AI tool to correctly identifying risks(s) associated with a project and to identify mitigating solutions to the identified risks. In some implementations, the prompt template customizes and/or formats the prompt or prompt templates with information relating to the risk identification and mitigation agent 218, such that the prompt is provided in a format that is acceptable by and is most likely to result in accurate results from the risk identification and mitigation agent 218. In an example, this involves providing a context for project, identifying the tasks(s), providing a description of the required output, and/or providing expectations. FIG. 4A illustrates an example prompt constructed for submission to a risk identification and mitigation agent. As depicted, the prompt includes a portion 402 that provides context for the request, a portion 404 that lays out the task, a portion 406 that specifics the output required, and a portion 408 that describes the expectation. Thus, the prompt is specifically generated to assist the AI model used by the risk identification and mitigation agent to generate accurate and relevant results.

The prompt is then transmitted to the risk identification and mitigation agent 218, which receives the prompt as an input and generates a list of one or more risks associated with the project, as well as mitigations that can be used to alleviate one or more of the risks. The risk identification and mitigation agent 218 may be the same as the risk identification agent 152 of FIG. 1 or it may be a different AI tool. While the risk identification and mitigation agent 218 is displayed as being part of the risk management system 144, the risk identification and mitigation agent 218 may be an AI service that is external to the risk management system 144 and is accessed via an API or other mechanism.

In some implementations, the identified risks are transmitted to the risk reviewing agent 220. The risk reviewing agent 220 may be the same element as the risk reviewing agent 152 of FIG. 1. The risk reviewing agent 220 is an AI tool that is used to validate the identified risks. In an example, the risk reviewing agent 220 is an agent that leverages a generative AI tool such as an LLM to validate identified risks. Examples of such models include but are not limited to a Generative Pre-trained Transformer 3 (GPT-3), or GPT-4 model. Other implementations may utilize other models or other generative models to determine whether identified risks are valid. In an example, the risk reviewing agent 152 is a ML model that is finetuned to review the risks identified by the risk identification agent 150 and to determine whether the identified risks are valid risks. To finetune such a model, data regarding identified risks and user feedback regarding whether or not the identified risks are accurate may be collected and used to label the identified risks in order to generate a training dataset for finetuning the model.

When the risk reviewing agent 220 determines that the identified risks are invalid or that a specific number or percentage of the identified risks are invalid (e.g., a number or percentage meeting a threshold), the risk reviewing agent 220 transmits the invalid risks to the user proxy 224, which is an agent (e.g., an AI tool) that functions as a proxy for the user. In an example, the user proxy 222 is a generate AI model such as an LLM that receives the invalid risks as an input in the form of a prompt and generates a query that is transmitted to the prompt construction engine 216 to modify the initial prompt generated for the risk identification and mitigation agent 218. For example, the user proxy may generate a natural language request that identifies the invalid risks and transmit those to the prompt construction engine 216 which, in turn, identifies those risks as invalid risks for insertion into a prompt template to generate the next prompt transmitted to the risk identification and mitigation agent 218. The process may be repeated until a desired number or percentage of valid risks are generated by the risk identification and mitigation agent 218. In this manner, a multi-agent process is used to refine the output generated by the risk identification and mitigation agent 218 until a desired level of Accuracy is achieved. Thus, the risk identification and mitigation agent 218 and risk reviewing agent 220 work together in an agentic workflow until both agents determine that the generated output meets a threshold requirement.

Once the identified risks are validated, the risk reviewing agent 220 transmits the identified risks and/or any identified mitigating solutions for the identified risks as the output 220 to the application 112 or 114 for being displayed to the user. In an example, the output 220 is displayed via a user interface element of the application 112 or 114, such as a project management dashboard.

FIG. 3 depicts another example of some elements involved in identifying risks associated with a project and determining mitigating solutions for the identified risks. In an example, the process is initiated when a user using an application that offers project management assistance (e.g., a copilot) submits a query 308 for assistance in managing a project and/or in identifying risks associated with a project. The user request may be in natural language and may be submitted as a text that is entered into a user input element such as an input box of a bot or copilot application. Alternatively, the user interface element may be a button on a project management application that a user can select to request identification of risks associated with an identified project. When the query is in a natural language format (e.g., “help me identify risks for my project titled “Fundraising Event”), the text may be included in the prompt transmitted to the generative AI tool, as further discussed below. In an example, this is achieved by transmitting the query to a request processing unit such as the request processing unit 146 of FIG. 1, which determines that the request should be transmitted to risk management system 144. Along with the request, metadata about the requesting user and/or the project may be transmitted to the request processing unit and/or the risk management system 144. Based on the metadata, the risk management system may retrieve 302 for use in processing the query 308.

The data 302 may include project data as well as contextual data such as the additional data 226 discussed above with reference to FIG. 2. As previously discussed, the project data may include the name of the project, names or other identification information for the team members responsible for the project, vendors associated with the project, the type of project, project tasks, project timeline, resources required for the project (e.g., computing resources, products, etc.) and the like. This data may be retrieved from enterprise graph storage, project data stores and the like. The additional/contextual data may include contextual data about the project, such as data about the users associated with the project (e.g., their calendar data, their schedules, their skill set, their communications, etc.), communications associated with the project (e.g., emails having the project title included in the subject, instant messages between team members associated with the project, instant messages in virtual meetings with the same title as the project, and the like), data related to vendors associated with the project, and the like. In an example, an API is used to collect the data and the API specifies which metadata to retrieve with the data. The data 302 is transmitted to the prompt construction engine 310 to be used in constructing the prompt transmitted to the risk identification and mitigation agent 312.

Additionally, the data 302 is transmitted to a segmentation engine 304, which decomposes the data 302 into small segments (e.g., chunks) that can be transmitted to the embedding engine 306 and which are consumable by the generative AI tool (e.g., LLM). The smaller data segments are used by the embedding engine 306 to generate embeddings (e.g., numerical features). The embedding engine 306 is an AI tool that can be used to create vector embeddings from textual data. For projects that are associated with users (e.g., project tasks are assigned to one or more users) and/or other enterprises (e.g., vendors), this process includes generating user profile/vendor profile embeddings, which may include a summary of the user/vendor's skillsets/resources. For a user, this may include retrieving a list of tasks the user is associated with in various projects, retrieving user identification information such as the user's email address and summarizing the tasks to identify relevant skillsets. The identified skillsets are then used to generate an embedding for the tasks each user is qualified to perform. In some implementations, the user embeddings are generated offline. For example, a timer job may be created that generates user embeddings and user summaries for users associated with an enterprise based on a pre-determined schedule (e.g., once a month). The embeddings are derived from user's assigned tasks and are stored in a user vector embedding database. Then, when a request to identify risks associated with a project is received, the tasks associated with the project are used to generate task embeddings for one or more of the tasks associated with the project. The task embeddings are also stored in a vector database (not shown), on which a relevant data search can be performed. In addition to converting the data 302 (e.g., task data and user data), the embedding engine 306 may also be used to convert the query 308 into one or more vector embeddings. The query embeddings may also be stored in the same or a different vector database on which a relevancy search can be conducted.

The generated data embeddings and the query embeddings are then compared by the comparing engine 322. In an example, the comparing engine 322 is an element that can conduct a search on vector embeddings and identify embeddings that are similar to each other. For example, the comparing engine 322 may be an element that performs a cosine similarity operation to compare the query 308 to the data 302 and identify elements in the data 302 that are relevant to the query 308. In another example, the comparing engine 322 compares the task embeddings to the user embeddings to identify users that are relevant to the tasks. The results of the comparison are ranked (e.g., based on a comparison score) and the most relevant results are transmitted to the prompt construction engine 310 to be included in the prompt. In an example, a top number (e.g., top K results) or a top percentage (e.g., top 10%) of the results are selected for transmission. In one embodiment, the comparing engine 322 implements a Retrieval Augmented Generation (RAG) pattern, to retrieves data segments similar to the user request/query, based on comparing the embeddings. The technical advantage of this approach as compared to providing all of the data to the LLM is that instead of including all of the retrieved data 302, which may result in an incorrect output or invalid from the generative AI tool, only a portion of the most relevant data is provided in the prompt. This not only increases accuracy, it may also increase efficiency, as fewer iterations of revising the prompt may be needed, and the risk identification and mitigation agent 312 may operate more efficiently, as the prompt size is more manageable. Furthermore, the comparison allows identification of resources (e.g., users, vendors, etc.) that can be used to mitigate risks associated with project tasks. This information is included in the prompt and used by the risk identification and mitigation agent 312 to generate recommended mitigations that are likely to be relevant to the identified risks.

The prompt construction unit 202 inserts the received query 308 and the relevant data 302 into a prompt template to generate a prompt that includes the data for transmission to the risk identification and mitigation agent 312. The prompt template used by the prompt construction engine 310 customizes and/or formats the prompt or prompt templates with information relating to the risk identification and mitigation agent 312 such that the prompt is provided in a format that is acceptable by and is most likely to result in accurate results from the risk identification and mitigation agent 312. The prompt construction engine 310 may operate in a similar manner as that discussed above with respect to the prompt construction engine 216 of FIG. 2.

The prompt is then transmitted to the risk identification and mitigation agent 312, which receives the prompt as an input and generates a list of one or more risks predicted for the project, as well as mitigation solutions for addressing the identified risks as an output. As discussed with respect to FIG. 2, the output may be provided to the risk reviewing agent 314 which reviews the identified risks for accuracy, relevance and conciseness. The risk reviewing agent 220 may include the same elements and/or operate in a similar manner as the risk reviewing agent 220 of FIG. 2.

When the risk reviewing agent 314 determines that the identified risks and/or the identified mitigations are invalid or that a specific number or percentage of the identified risks are invalid (e.g., a number or percentage meeting a threshold), the risk reviewing agent 314 transmits the invalid risks/mitigations to the user proxy 316, which is an agent (e.g., an AI tool) that functions as a proxy for the user. The user proxy 316 may be a generative AI model such as an LLM that receives the invalid risks/mitigations as an input in the form of a prompt and generates a query that is transmitted to the prompt construction engine 310 to modify the initial prompt generated for the risk identification and mitigation agent 312. The process is repeated until a desired number or percentage of valid risks are generated by the risk identification and mitigation agent 312. The multi-agent process ensures accuracy and efficiency in identifying concise and accurate risks and mitigating solutions.

FIG. 4B depicts an example of identified risks/mitigation actions that are not precise and/or contextual. For example, as can be seen the first identified risk is “delay in clearing personal properties on converting a private plan to a shared plan.” While this provides some information, the identified risk, risk description and risk mitigation actions are vague and imprecise. FIG. 4C depicts an example of identified risks/mitigation actions for a structured project, where the identified risks/mitigation actions are relevant and more precise. The identified information include a specific risk name (Delayed External Apps Code Changes), risk label, risk description, risk scenario, risk rank, a reason for the risk rank, the reason for the risk severity, and multiple mitigation actions. FIG. 4D depicts an example of identified risks/mitigation actions for an unstructured project, the identified risks/mitigation actions being relevant and precise. An unstructured project refers to a project that has disconnected themes. As depicted, the output includes a risk name, risk label that identifies the risk as being external, risk callout reason, risk description, risk scenario, and risk mitigation actions which specific the type of mitigation action to be taken as well as who the task should be assigned to, the estimated time for the task, etc. Referring back to FIG. 3, by reviewing/validating the output, the risk reviewing agent 314 can determine whether the output meets a desired threshold of accuracy/conciseness.

Once the identified risks/mitigations are validated, the risk reviewing agent 314 transmits the identified risks and/or any identified mitigating solutions for the identified risks as an output 320, which is then transmitted to the application 112 or 114 for being displayed to the user. In an example, in addition to the output generated by the agent 312/314, a capacity data 318 is also included in the output 320 for transmission to the application 112 or 114. The capacity data 318 may be retrieved from user data/vendor data, when the recommended mitigation includes a reference to using a specific user/vendor/other resource instead of one that is allocated to the project. For example, if an engineer assigned to the project is identified as a risk factor for being unavailable (e.g., sick), then the recommended mitigation may be a suggestion to replace the assigned engineer with another specific person. This information is then used to retrieve capacity data for the recommended engineer to be included in the output. The capacity data may be retrieved from other projects' to which the recommended engineer is assigned, from calendar data of the recommended engineer and the like. It should be noted that in retrieving and using user data, care is taken to ensure compliance with privacy and confidentiality guidelines and regulations. The capacity data when displayed with the recommended mitigation enables the user (e.g., project manager) to quickly determine whether the recommended resource has the capacity to take on the task.

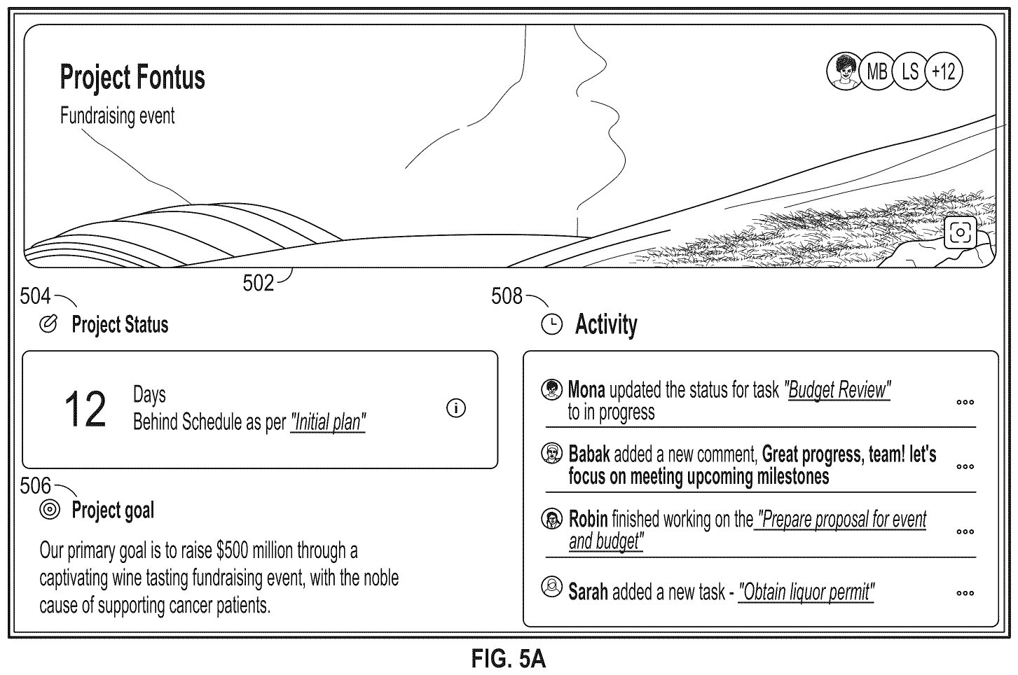

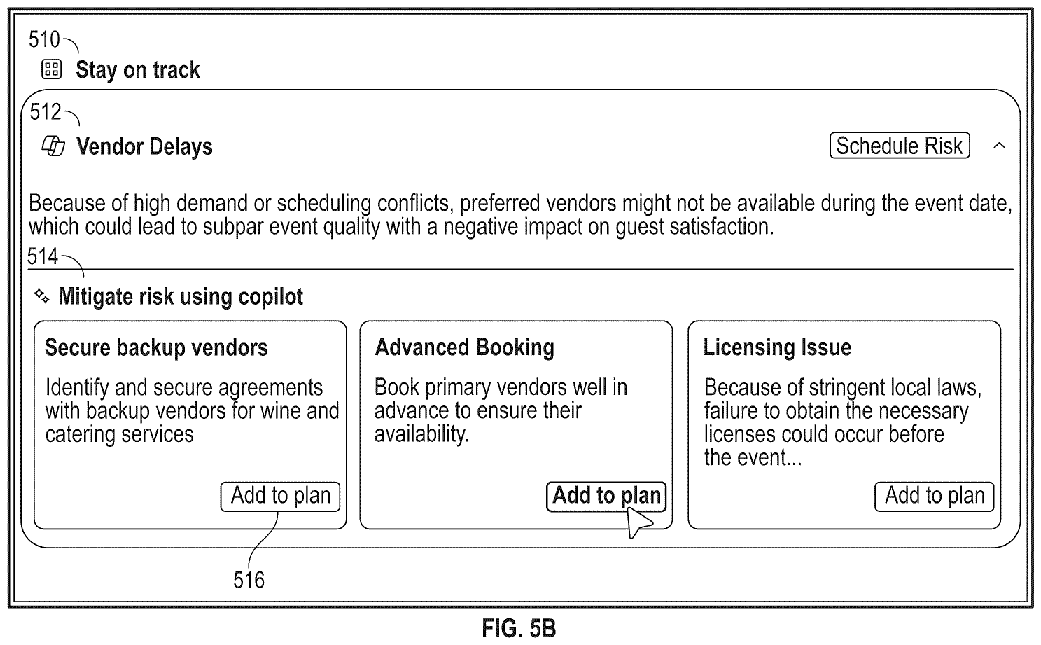

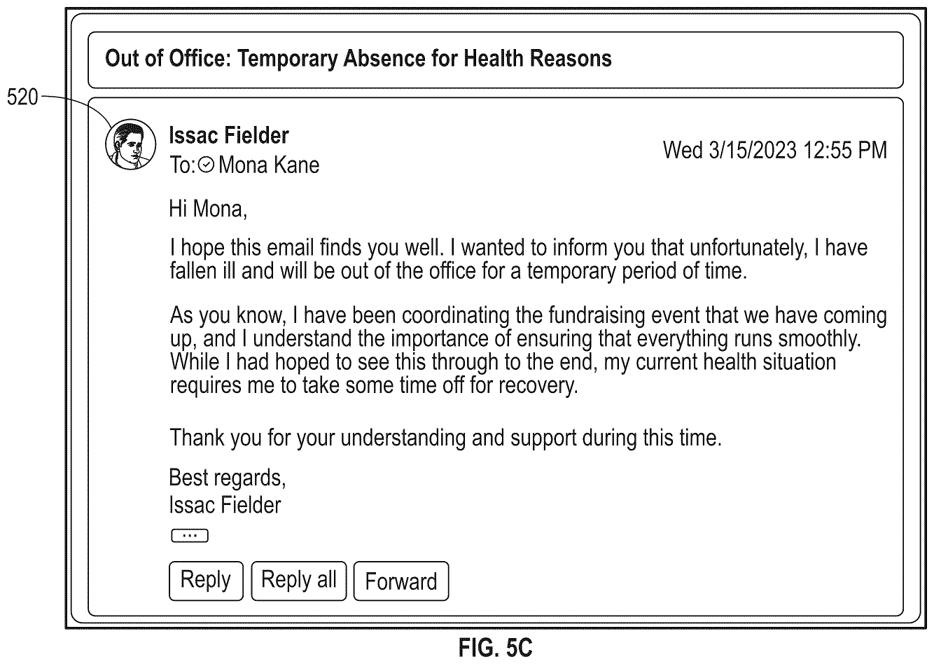

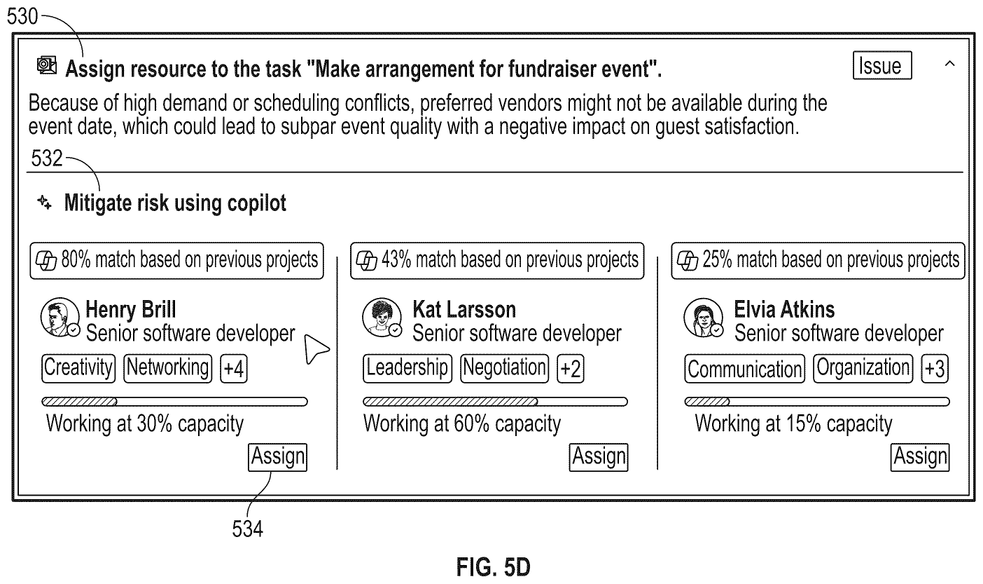

FIGS. 5A-5D depict example graphical user interfaces (GUIs) of an example project management application that implements aspects of this disclosure. The GUI screen 502 of FIG. 5A displays an example GUI screen of a project management application or service, or a copilot application or service that enables users to organize/manage their projects. The GUI screen 502 may be depicted once a user selects a specific project such as Project Fontus, from among a list of projects to which the user has access or when the user submits a request (e.g., natural language request) to review a project to which the user has access. As depicted, the GUI screen 502 displays the name of the project and includes a project status pane 504, a project goal pane 506 and a project activity pane 508. The project status pane 504 displays the current status of the project, which may include the timeline, e.g., indicating that the project is 12 days behind schedule. The project goal pane 506 displays the goal set for the project. The goal may be retrieved from project data which may include data submitted by a user when the project was generated in the system. The project activity pane 508 displays a list of the latest activities performed with respect to the project.

The GUI screen 510 of FIG. 5B depicts a risk identification and mitigation recommendation screen that may be displayed when the user submits a natural language query to the copilot application requesting identification of risks and/or mitigation actions, or when the user selects a UI element to submit a request for identifying risks associated with a selected project. In some implementations, the UI element is provided on the GUI screen 502.

The GUI screen 510 includes a risk identification pane 512 which provides a list of one or more identified risks, along with a description of the identified risk. In some implementations, additional information about the risk may be displayed (e.g., risk label, risk severity, etc.) for each identified risk. The GUI screen 510 also includes a risk mitigation pane 514 which depicts a number of recommendations for mitigating the identified risk. In the example displayed in the GUI screen 510, the recommended mitigation actions include securing backup vendors, advanced booking and licensing issues. A UI element 516 is depicted below each recommended mitigation action, which once selected enables the user to add the recommended action to the project plan. In this manner, not only does the system recommend mitigations but it also enables the user to quickly and efficiently add the recommendations to the project plan to ensure they are taken care of.

The GUI screen 520 of FIG. 5C depicts an example email message that may be sent by one of the people responsible for one or more tasks of a project. The email messages indicates that the person will be out of the office due to an illness. The email message may be a communication between team members of the same project, between a team member of the project and that member's manager or the like. By utilizing the risk management system, the system disclosed herein is able to identify and retrieve such communications, and take them into consideration when identifying risks associated with a project.

The GUI screen 530 of FIG. 5D depicts another example risk identification and mitigation recommendation screen. In the screen 530, the identified risk is potential vendor unavailability and the recommended mitigation actions are assigning the task to potential identified users. The risk mitigation pane 532 of FIG. 5D includes a list of three recommended users that can be assigned to the task. The screen displays each recommended user's name, job title, skill set, and work capacity. The reviewing user can take this information into account when deciding which user to assign the task to. Once a decision has been made, the user can invoke the UI element 543 displayed below each recommended user to assign the task to that user. In this manner, the user is not only able to review identified risks and receive recommendations for mitigating the risk, but the user is also presented with options with additional information that can help the user select the best option. Furthermore, the user can utilize the same screen to ask the task to the selected user.

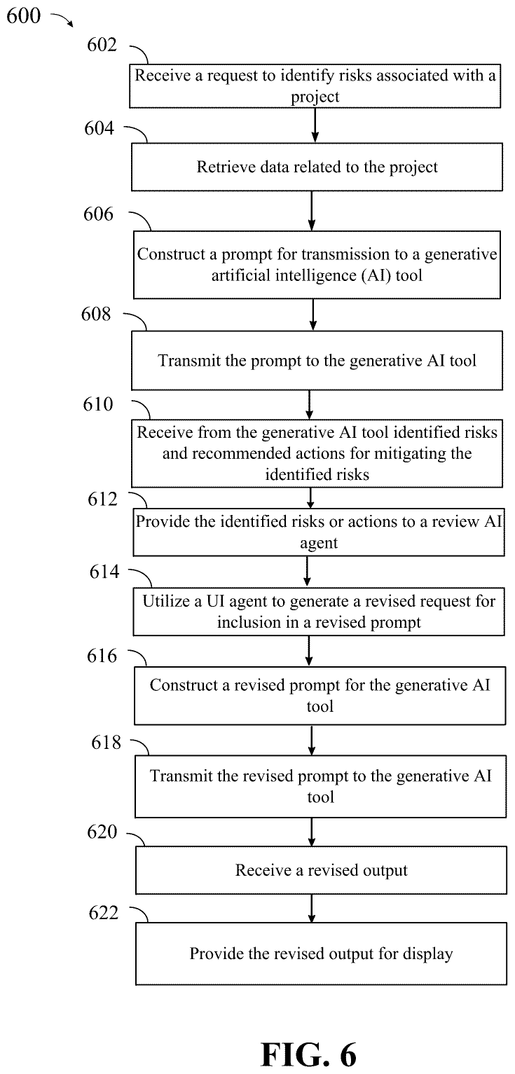

FIG. 6 is a flow diagram depicting an exemplary method 600 for intelligently identifying risks and mitigation actions for a project. At least some of the steps of method 600 are performed by a risk management system such as the risk management system 144 of FIGS. 1-3. Method 600 begins and proceeds to receive a request to identify risks associated with a project, at 602. The request may be received from a user, via a UI of an application or service and may be in natural language, as discussed above. In an alternative implementation, the request may be automatically invoked, for example, based on a predetermine schedule for one or more ongoing projects of an enterprise. For example, an enterprise or a manager may select a setting for identifying risks associated with each ongoing project based on a predetermine schedule (e.g., once a week).

After receiving the request, method 600 proceeds to retrieve data related to the project, at 604. The data may include project data, user data and/or additional data related to the project, users, vendors, and the like. Once the required data is retrieved, a prompt is constructed via a prompt construction engine, for transmission to a generative AI tool, at 606. The prompt includes at least some of the retrieved data and is transmitted to the generative AI tool, at 608. In response to transmitting the prompt, one or more identified risks for the project and one or more recommended actions for mitigating at least one of the identified risks are received from the generative AI tool, at 610.

The identified risks and/or recommended actions for mitigating the identified risks are then provided to a review AI agent for validation, at 612. The review AI agent determines whether the identified risks and/or recommended actions are valid (e.g., accurate, precise, etc.). In response to a threshold number of the identified risks or the recommended actions being invalidated, method 600 utilizes a user agent to generate a revised request for inclusion in a revised prompt to the generative AI tool, at 614. The revised request identifies at least one of the invalidated risks or invalidated recommended actions. In this manner, method 600 utilizes a multi-agent process to ensure efficiency and accuracy of the process.

Upon receiving the revised request, the prompt construction engine constructs a revised prompt for transmission to the generative AI tool, at 616. The revised prompt may include information about the invalidated risks/recommended action and may include the revised request which may specify a request for generating more precise risks/recommended actions or for not including the invalidated risks/recommended actions. After the revised prompt is constructed, it is transmitted to the generative AI tool, at 618. In response, a revised output is received from the generative AI tool, at 620. The revised output includes one or more revised identified risks or one or more revised recommended actions for mitigating the one or more revised risks. The revised output, or the original output if the threshold number of invalid risks are not identified, is provided for display to a user, at 622.

In some implementations, to enable the generative AI tool to identify accurate recommended actions for mitigating the risks, such as identifying alternative users/vendors for performing tasks associated with the project, user embeddings for one or more users associated with an enterprise are generated. The user embeddings may include information about at least one of tasks the one or more users are associated with or skillsets the one or more users have. Additionally, task embeddings are generated for one or more tasks associated with the project and the task embeddings are compared to the user embeddings to identify relevant users for the one or more tasks associated with the project; and providing the identified relevant users to the prompt construction engine for inclusion in the prompt.

FIG. 7 is a block diagram 700 illustrating an example software architecture 702. This architecture may be used in each of the various services described above. Also, various portions of this architecture may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and Input/Output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. The machine 800 may be used to implement any of the services described in the system above.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-8) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for identifying one or more risks associated with a project, the data processing system comprising:
a processor; and
a memory in communication with the processor, the memory comprising executable instructions that, when executed by the processor alone or in combination with other processors, cause the data processing system to perform functions of:
receiving a request to identify risks associated with the project;
retrieving data related to the project;
generating a prompt for transmission to a generative artificial intelligence (AI) tool, the prompt including at least some of the retrieved data;
transmitting the prompt to the generative AI tool;
receiving from the generative AI tool one or more identified risks for the project and one or more recommended actions for mitigating at least one of the identified risks;
providing the one or more identified risks and the one or more recommended actions for mitigating the at least one of the one or more identified risks to a review AI agent for validating at least one of the one or more identified risks and the one or more recommended actions;
in response to a threshold number of the one or more identified risks or the one or more recommended actions being invalidated, utilizing a user agent to generate a revised request for including in a revised prompt to the generative AI tool, the revised request identifying at least one of the invalidated risks or invalidated recommended actions;
generating the revised prompt for transmission to the generative AI tool;
transmitting the revised prompt to the generative AI tool;
receiving from generative AI tool a revised output include one or more revised identified risks or one or more revised recommended actions for mitigating the one or more revised risks; and
providing the revised output for display to a user.

2. The data processing system of claim 1, wherein the one or more recommended actions for mitigating the at least one of the identified risks are identified by:
generating user embeddings for one or more users associated with an enterprise, the user embeddings including information about at least one of tasks the one or more users are associated with or skillsets the one or more users have;
generating task embeddings for one or more tasks associated with the project; and
comparing the task embeddings to the user embeddings to identify relevant users for the one or more tasks associated with the project; and
providing the identified relevant users for inclusion in the prompt.

3. The data processing system of claim 2, wherein the information about the one of tasks the one or more users are associated with or skillsets the one or more users have is first segmented before user embeddings are generated.

4. The data processing system of claim 2, wherein the user request is converted to an embedding and used in comparing the task embeddings to the user embeddings.

5. The data processing system of claim 2, wherein at least one of the user embedding or the task embeddings are stored in a vector database.

6. The data processing system of claim 1, wherein the one or more recommended actions or the one or more revised recommended actions include recommending to assign a task associated with the project to a new user, the new user being a user with matching skills associated with users related to the project or to project requirements.

7. The data processing system of claim 6, wherein the revised output includes capacity information for the new user.

8. The data processing system of claim 1, wherein the output or the revised output is provided for display in a dashboard for the project.

9. A method for identifying at least one of risks and actions for mitigating the risks associated with a project, the method comprising:
receiving a request to identify risks associated with the project;
retrieving data related to the project;
constructing a prompt for transmission to a generative artificial intelligence (AI) tool, the prompt including at least some of the retrieved data;
transmitting the prompt to the generative AI tool;
receiving from the generative AI tool at least one of one or more identified risks for the project and one or more recommended actions for mitigating at least one of the identified risks;
providing the one or more identified risks and the one or more recommended actions for mitigating the at least one of the one or more identified risks to a review AI agent for validating at least one of the one or more identified risks and the one or more recommended actions;
in response to a threshold number of the one or more identified risks or the one or more recommended actions being invalidated, utilizing a user agent to generate a revised request for including in a revised prompt to the generative AI tool, the revised request identifying at least one of the invalidated risks or invalidated recommended actions;
constructing the revised prompt for transmission to the generative AI tool;
transmitting the revised prompt to the generative AI tool;
receiving from generative AI tool a revised output include one or more revised identified risks or one or more revised recommended actions for mitigating the one or more revised risks; and
providing the revised output for display to a user.

10. The method of claim 9, wherein generative AI tool is a large language model.

11. The method of claim 9, further comprising:
generating user embeddings for one or more users associated with an enterprise, the user embeddings including information about at least one of tasks the one or more users are associated with or skillsets the one or more users have;
generating task embeddings for one or more tasks associated with the project; and
comparing the task embeddings to the user embeddings to identify relevant users for the one or more tasks associated with the project; and
providing the identified relevant users for inclusion in the prompt.

12. The method of claim 11, wherein the information about the one of tasks the one or more users are associated with or skillsets the one or more users have is first segmented before user embeddings are generated.

13. The method of claim 11, wherein the user request is converted to an embedding and used in comparing the task embeddings to the user embeddings.

14. The method of claim 11, wherein at least one of the user embeddings or the task embeddings are stored in a vector database.

15. The method of claim 9, wherein the one or more recommended actions or the one or more revised recommended actions include recommending to assign a task associated with the project to a new user, the new user being a user with matching skills associated with users related to the project or to project requirements.

16. The method of claim 15, wherein the revised output includes capacity information for the new user.

17. A non-transitory computer readable medium on which are stored instructions that, when executed, cause a programmable device to perform functions of:
receiving a request to identify risks associated with a project;
retrieving data related to the project;
constructing a prompt for transmission to a generative artificial intelligence (AI) tool, the prompt including at least some of the retrieved data;
transmitting the prompt to the generative AI tool;
receiving from the generative AI tool one or more identified risks for the project and one or more recommended actions for mitigating at least one of the identified risks;
providing the one or more identified risks and the one or more recommended actions for mitigating the at least one of the one or more identified risks to a review AI agent for validating at least one of the one or more identified risks and the one or more recommended actions;
in response to a threshold number of the one or more identified risks or the one or more recommended actions being invalidated, utilizing a user agent to generate a revised request for including in a revised prompt to the generative AI tool, the revised request identifying at least one of the invalidated risks or invalidated recommended actions;
constructing the revised prompt for transmission to the generative AI tool;
transmitting the revised prompt to the generative AI tool;
receiving from generative AI tool a revised output include one or more revised identified risks or one or more revised recommended actions for mitigating the one or more revised risks; and
providing the revised output for display to a user.

18. The non-transitory computer readable medium of claim 17, wherein the request is received via a project management application or service.

19. The non-transitory computer readable medium of claim 17, wherein the request is received via a copilot application or service.

20. The non-transitory computer readable medium of claim 17, wherein the instructions when executed, further cause a programmable device to perform functions of:
generating user embeddings for one or more users associated with an enterprise, the user embeddings including information about at least one of tasks the one or more users are associated with or skillsets the one or more users have;
generating task embeddings for one or more tasks associated with the project; and
comparing the task embeddings to the user embeddings to identify relevant users for the one or more tasks associated with the project; and
providing the identified relevant users for inclusion in the prompt.
